(19) United States
(12) Patent Application Publication
(10) Pub. No.: US 2016/0380975 A1
(43) Pub. Date: Dec. 29, 2016

(54) Domain Name Service Redirection for a Content Delivery Network with Security as a Service

(71) Applicant: Cisco Technology, Inc., San Jose, CA (US)

(72) Inventors: Tirumaleswar Reddy, Bangalore (IN); Steven Stites, Austin, TX (US); Prashanth Patil, Bangalore (IN)

(21) Appl. No.: 14/748,499

(22) Filed: Jun. 24, 2015

(51) Int. Cl. H04L 29/06; H04L 29/12; H04L 29/08

(52) U.S. Cl. CPC H04L 63/0281; H04L 67/10; H04L 67/28; H04L 61/1511; H04L 67/02; H04L 61/6004

(57) ABSTRACT

In one implementation, a cloud connector obtains location information for a proxy server of a security as a service (SecaaS) function. The cloud connector receives a content request from a user device for content hosted in a content delivery network (CDN). A domain name service (DNS) request, with location information, is forwarded to a DNS authoritative server. An identification of a downstream CDN server is received from the DNS authoritative server. The identification of the downstream CDN is based on the location information for the proxy server of the SecaaS function. The content is obtained from the downstream CDN server through the proxy server of the SecaaS function.

### TECHNICAL FIELD

This disclosure relates in general to the field of computer networks and, more particularly, to providing content from a content delivery network (CDN) with cloud-based security as a service (SecaaS).

### BACKGROUND

A CDN is used for large-scale content delivery, via prefetching or dynamically caching content on distributed surrogates or caching servers. The same content is distributed to different servers in an Internet protocol (IP) network, allowing provisioning of content more local to any requester. A domain name service (DNS) authoritative server redirects a given request to a downstream CDN (dCDN) server near the requester of the content.

In SecaaS, a cloud connector (e.g. ScanSafe or Cloud Web Security (CWS) connector) redirects hypertext transfer protocol (secure) (HTTP(S)) traffic to the SecaaS for inspection. SecaaS performs application and protocol detection, deep packet inspection, heuristics, or other inspection to detect malware, exploit scripts, data leakage, or identify other issues. Where SecaaS operates with CDN, the DNS authoritative server locates the dCDN based on the requester location. The HTTP(S) proxies provided by the SecaaS Datacenter (DC) and the end user may be in different geographic locations. Since the content is routed to the SecaaS, a sub-optimal path for the content (e.g., from the dCDN to SecaaS and then to the requester) results despite the attempt to optimize the path by DNS redirection.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a simplified block diagram of a CDN operating with SecaaS in accordance with an embodiment;

FIG. 2 is a flow chart diagram of one embodiment of a method for optimizing content delivery using DNS redirection with SecaaS;

FIG. 3 is a flow chart diagram of one embodiment of a method for exception handling in the method of FIG. 2; and

FIG. 4 is block diagram of a network device, according to one embodiment, for content delivery using DNS redirection with SecaaS.

### DESCRIPTION OF EXAMPLE EMBODIMENTS

### General Overview

The IP address or IP address prefix of a proxy, such as a SecaaS proxy server, is provided to the DNS authoritative server. The dCDN is identified based on the IP address or IP address prefix of the proxy rather than of the content requestor. While described below for SecaaS as the proxy, other proxy services or arrangements may be used.

In one aspect, a method is provided. A cloud connector device obtains location information for a proxy server of a security as a service (SecaaS) function. The cloud connector device receives a content request from a user device for content hosted in a CDN. A DNS request, with location information, is forwarded to a DNS authoritative server. An identification of a downstream CDN server is received from the DNS authoritative server. The identification of the downstream CDN is based on the location information for the proxy server of the SecaaS function. The content is obtained from the downstream CDN server through the proxy server of the SecaaS function.

In another aspect, logic encoded in one or more non-transitory computer-readable media includes code for execution. When executed by a processor, the logic is operable to receive a DNS message for content stored in a CDN, the DNS message having address information of a SecaaS server, identify a downstream CDN server based, at least in part, on the address information for the SecaaS server, and transmit an address for the downstream CDN server in response to the DNS message.

In yet another aspect, a system is provided. A client device connects to a network. The client device is configured to request content from a CDN. A gateway device of the network is configured to inform a DNS recursive server of IP address information of a proxy server for the content and is configured to receive an IP address of a downstream CDN server of the CDN selected using the IP address of the proxy server.

### Example Embodiments

To address the problem of DNS redirection for CDN creating sub-optimal paths due to the use of a proxy (e.g., SecaaS), information is provided to the upstream CDN to locate a dCDN located closer to the SecaaS datacenter. The cloud connector learns the subnet information of HTTP(S) proxies (e.g., servers) in the SecaaS datacenter and instructs the enterprise DNS recursive server to include this information in DNS requests so that the upstream CDN (e.g., DNS authoritative server) locates the dCDN closest or closer to the SecaaS datacenter. The cloud connector determines the proxy server's IP subnet and uses that IP address information instead of the originating client's IP subnet. In one embodiment, the proxy address for locating the dCDN is used with CLOUD WEB SECURITY (CWS) to locate Akamai or other edge servers closer to the CWS datacenter.

DNS redirection is based on the location of the SecaaS datacenter instead of the location of the client, thus improving the user experience. SecaaS may extend the path of the content, but the CDN attempt to optimize the path is altered to account for the use of SecaaS.

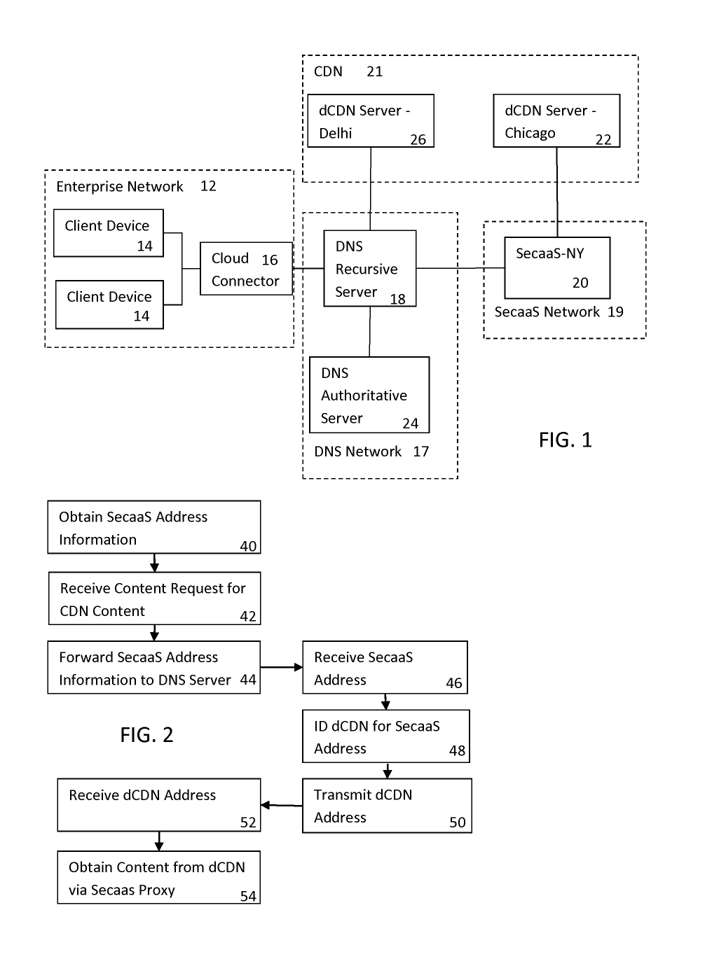

FIG. 1 shows an example network 10 for use of a CDN with cloud-based security as a service (SecaaS). The network 10 or a portion thereof is a system for domain name service (DNS) redirection for CDN operating with SecaaS. Rather than redirecting to the downstream CDN (dCDN) based on the requester of content, the dCDN is selected based on the SecaaS location. The path for serving the content passes through the proxy for the SecaaS, so the dCDN is selected based on the geographic location of the proxy for the SecaaS.

The network 10 includes the enterprise network 12 connected to other servers and/or networks, such as the SecaaS network 19 with the SecaaS server 20, the CDN 21 with dCDN datacenters or servers 22, 26, and the DNS routers or servers 18, 24 of the DNS network 17. The discussion below will use servers, but the servers may be more generically identified as subnets and/or datacenters. For example, the SecaaS server 20 is one of multiple servers in a datacenter or SecaaS subnet. The portion (e.g. prefix) of the IP address for the subnet and/or datacenter may be used as the IP address of the SecaaS server 20 for purposes of DNS redirection.

The enterprise network 12 includes various network devices, including one or more client devices 14 and a gateway or cloud connector 16. The enterprise network 12 connects with or is part of a broader network 10. The enterprise network 12 connects through wires or wirelessly with other networks, such as the Internet, the CDN, the SecaaS network, and the DNS network. Any now known or later developed enterprise network 12 may be used.

The SecaaS server 20 is part of or accessible through the other network or networks 17, 19, 21. The SecaaS server 20 is a single device or a collection of network devices, such as in one or more datacenters. The SecaaS server 20 is implemented by one or more servers outside of the enterprise network 12 and may be part of the SecaaS network 19. Any now known or later developed SecaaS server 20 may be used.

The CDN 21 includes two or more (e.g., tens or hundreds) of geographically distributed servers 22, 26 as stand-alone devices or as part of a same number of datacenters or other separate subnetworks. In the example of FIG. 1, the two servers 22, 26 are in Delhi, India and Chicago, Ill., US. Any geographic location may be used. Any now known or later developed CDN may be used.

The DNS servers 18, 24 are within or separate from other networks 12, 19, 21, such as the DNS recursive server 18 being within or separate from the enterprise network 12. The DNS network 17 is a collection of network devices interacting to provide name services or routing. The DNS network 17 includes various network devices, such as the cloud connector 16 implementing a DNS forwarding server, any number of DNS recursive servers 18, and one or more DNS authoritative servers 24. Any now known or later developed DNS network 17 may be used.

Additional, different, or fewer components may be provided for the network 10, the enterprise network 12, SecaaS network 19, CDN 21, DNS network 17, and/or subnets thereof. For example, additional client devices 14 may be provided. As another example, additional cloud connectors 16 may be provided. Any number of servers or datacenters for providing the SecaaS, DNS redirection, and/or CDN may be used. In yet another example, a proxy service other than SecaaS uses the DNS redirection and dCDN assignment based on the proxy operation. Any proxy service may benefit by DNS redirection for CDN based on the location of the proxy.

The enterprise network 12 is shown as a box, but may be many different devices connected in a local area network, wide area network, intranet, virtual local area network, the Internet, or combinations of networks. Similarly, any of the other networks (e.g., SecaaS 19, CDN 21, or DNS 17) may be many different devices connected in a local area network, wide area network, intranet, virtual local area network, the Internet, or combinations of networks. Any form of network may be provided, such as transport networks, datacenter, or other wired or wireless network. The networks may be applicable across platforms, extensible, and/or adaptive to specific platform and/or technology requirements through link-negotiation of connectivity.

In the described embodiment, the network devices (e.g., client devices 14 or cloud connector 16) of the enterprise network 12 may be in a same room, building, facility, or campus. In other embodiments, the enterprise network 12 is formed with devices distributed throughout a region, such as in multiple states and/or countries. The enterprise network 12 is a network owned, operated, and/or run by or for a given entity.

The network devices of any of the networks are connected over links through ports. Any number of ports and links may be used. The ports and links may use the same or different media for communications. Wireless, wired, Ethernet, digital subscriber lines (DSL), telephone lines, T1 lines, T3 lines, satellite, fiber optics, cable and/or other links may be used. Corresponding interfaces are provided as the ports.

Any number of client devices 14 may be provided. The client devices 14 are computers, tablets, cellular phones, Wi-Fi capable devices, laptops, mainframes, or other user devices accessing content through the enterprise network 12. The client devices 14 connect to the enterprise network 12 through wires, such as Ethernet cables, or wirelessly, such as with Wi-Fi. The connections between client devices 13 and enterprise network 12 may be relatively fixed, such as for personal computers connected by wires to switches. Alternatively, the connections may be temporary, such as associated with mobile devices that access the enterprise network 12 as needed or when in range.

The client devices 14 are configured to request web-content. For example, a browser operating on one of the client devices 14 requests web content pursuant to TCP/IP. The request uses a uniform resource locator (URL) that includes an IP address as the IP address itself or as a domain name. As another example, an application requests an update or other information pursuant to any standard for communications in the enterprise network 12.

In some cases, the requested content is located on the CDN 21. Various dCDNs of the CDN 21 host copies of the requested content. For more rapid response, a dCDN near to the client device 14 and/or enterprise network 12 may be provided using DNS redirection. Where the requested content, once provided, is to be filtered or inspected by a SecaaS server 20 at a different location, the DNS redirection locates a dCDN near to the SecaaS server 20 instead of the client device 14.

The cloud connector 16 is a gateway device of the enterprise network 12. The cloud connector 16 may be, but is not limited to being, a network interface card, an edge router, other router, a firewall, or other network device. As a gateway device, the cloud connector 16 interfaces the enterprise network 12 with other networks, such as the SecaaS server 20 in the Internet. In one embodiment, the cloud connector 16 is a server implementing or operating as a DNS forwarding server. The cloud connector 16 is a processing device for receiving the request for content sent by the client device 14, communicating with the DNS network (e.g., DNS recursive server 18) based on the request for content, passing the request for content to the CDN 21 (e.g., dCDN server 22), and assuring inspection of the content by the cloud-based SecaaS server 20. Communications with other network devices may also be provided.

The cloud connector 16 and/or the DNS authoritative server 24 are configured by software, firmware, and/or hardware to alter the DNS redirection to account for use of SecaaS. The configuration accounts for the SecaaS function in identifying or selecting a dCDN to provide requested content. The various components of the network 10 are configured by hardware, firmware, and/or software to provide CDN-based content delivery, SecaaS, DNS redirection, or other operations. Logic is encoded in one or more non-transitory computer-readable media for operating the cloud connector 16, DNS recursive server 18, DNS authoritative server 24, and/or the SecaaS server 20. The media is a memory. Memories within or outside the enterprise network 12 may be used. The logic includes code for execution by a processor or processors, such as processors of the cloud connector 16. When executed by a processor, the code is used to perform operations for CDN 21, DNS redirection, and/or SecaaS. The logic code configures the device to perform operations.

FIG. 2 shows an embodiment of a method for DNS redirection to locate a dCDN based on the SecaaS. The acts are divided into two columns. The first column (acts 40, 42, 44, 52, and 54) are acts performed by the cloud connector 16 or other network device associated with the client device 14 or enterprise network 12. The second column (acts 46, 48, and 50) are acts performed by the DNS authoritative server 24 or other DNS router for implementing CDN provision of content. Acts for other network devices may be provided, such as the DNS recursive server 18 operating pursuant to DNS processes, the SecaaS server 20 inspecting content, and the dCDN server 22 hosting and providing content. Except as otherwise discussed herein, these other network devices operate pursuant to the corresponding process (e.g., DNS redirection, SecaaS, and CDN), so these additional acts are not detailed herein.

Additional, different, or fewer acts may be provided. For example, the methods are directed to serving a given request. Some or all of the acts are repeated for other requests. The acts are performed in the order shown (i.e., numerical or top to bottom) or a different order.

The method of FIG. 2 is implemented by the network of FIG. 1, by a cloud connector, by other enterprise network devices, by the DNS network, by the CDN network, by the SecaaS server, or by other networks or software. Any of various devices and corresponding applications may implement all or portions of the methods. For the discussion of FIG. 2 below, the network of FIG. 1 is used as an example.

In act 40, the cloud connector 16 obtains location information for the proxy server 20 of the SecaaS function. A secure communication channel is established with a management server of the SecaaS datacenter or other SecaaS server. An encrypted tunnel or other secure communication is typically used. Alternatively, a non-secure communication may be used. In another alternative embodiment, any communication with the SecaaS that includes the IP address for a subnet (e.g., IP address prefix for a server) or particular server 20 may be used to obtain the location information, even if the communication or subnet is received for a different purpose.

The cloud connector 16 requests subnet, IP address, or other information indicating a geographic location of the SecaaS server 20. For example, the subnet for a SecaaS datacenter is requested and/or received by the cloud connector 16. The subnet information of the hypertext transfer protocol (HTTP) or HTTP secure (HTTPS) proxy servers 20 in the SecaaS datacenter indicates the location. The subnet includes IP address information (e.g., IP address prefix) that may be used to determine the geographic location of the SecaaS datacenter. The IP address, IP address prefix, or other location information may be used to perform DNS redirection. As another example, the SecaaS server 20 provides a geographic location rather than an IP address.

As an alternative to requesting, the cloud connector 16 may have or have access to the subnet or other location information already stored. The location information may be provided upon initiation of the SecaaS function for the enterprise network 12 or uploaded to the cloud connector 16 or other network device of the enterprise network 12.

The SecaaS location information is obtained once and/or without reference to a specific request for content. The location information is obtained to be later used for processing requests for content from any of the client devices 14. A periodic or triggered update may be performed, such as occasionally requesting current subnet information for the proxy servers 20 of the SecaaS.

In act 42, the cloud connector 16 receives a content request from a user device 14 for content hosted in the CDN. The request for content may not specifically indicate hosting of the content by the CDN, but instead provides an IP address for the content from the URL. The DNS authoritative server 24 or cloud connector 16 identifies the IP address of the content as being hosted by the CDN, so redirects the request for content to a selected dCDN. Alternatively, the request for content includes an indication that the content is hosted by the CDN, so causes redirection of the request to the CDN.

The cloud connector 16 intercepts the request from the user. The request may not be addressed to the cloud connector 16, but the cloud connector 16 is along the path of travel or route for the request, so examines the request. In other embodiments, the request is directed to the cloud connector 16, so the cloud connector 16 intercepts by receiving. Since the request is for content not served by the cloud connector 16, the request is intercepted.

The cloud connector 16 operates as a transparent proxy. Any requests for content are routed through the cloud connector 16, so substantially all requests may be intercepted. “Substantially” accounts for communications with trusted sources not handled by the cloud connector 16. Where multiple cloud connectors 16 are provided, each given cloud connector 16 intercepts all or certain requests for content routed through or received at that given cloud connector 16. The transparent proxy allows the client devices 14, CDN, and SecaaS to operate as if the cloud connector 16 where not part of the content hosting and not part of the SecaaS function with respect to any given request.

In act 44, the cloud connector 16 forwards the location information for a DNS request to the DNS authoritative server 24. The cloud connector 16 operates as a router forwarding the DNS request. The DNS request is a DNS message with the IP address for the requested content. The DNS request is sent directly to the DNS authoritative server 24 or through one or more DNS recursive servers 18.

The DNS request informs the DNS recursive server 18 to route the DNS request to the DNS authoritative server 24. By generating the DNS request and forwarding to the DNS recursive server 18, the cloud connector 16 causes the DNS message to be sent to the DNS authoritative server 24. This DNS process or a different DNS process is performed to determine the actual IP address to use for the content under CDN. In alternative embodiments, the client device 14 generates the DNS message, which is intercepted by the cloud connector 16 and forwarded to the DNS recursive server 18 or DNS authoritative server 24.

The DNS request or message includes the location information for the SecaaS server 20. The cloud connector 16 is configured to inform the DNS recursive server 18 of the IP address of the proxy server 20 for the content, such as informing of the subnet information for the SecaaS server 20. Alternatively, the explicit geographic location (e.g., coordinates, city, state, county, zip code, and/or country) is determined from the subnet or other IP address and communicated to the DNS recursive server 18. In yet other embodiments, the explicit geographic location requested from the SecaaS proxy is passed to the DNS recursive server 18. In another embodiment, any information specific to the SecaaS proxy useable or used for DNS redirection to implement CDN may be provided by the cloud connector 16 to the DNS recursive server 18.

The location information, in the form of an explicit location or the form of an IP address (e.g., subnet), is communicated to the DNS network in any format. In one embodiment, the cloud connector 16, acting as a DNS forwarding server, generates or alters the DNS message. The DNS message is altered or generated to include the location information. Since the DNS message may be altered by the DNS recursive server 18 to include the DNS recursive server 18 addressing, the location information may be lost. Accordingly, an extension mechanism for DNS (EDNS) is used to pass the location information. For example, an EDNS version 0 (EDNSO) option is defined or established for passing proxy location information with the DNS message. While the DNS recursive server 18 may use its own address in passing the DNS message to the DNA authoritative server 24, the EDNS is maintained in the DNS message. By communicating with EDNS option, the cloud connector 16 causes the DNS recursive server 18 to create or forward a DNS message for the DNS authoritative server 24 with an EDNS option in the DNS message having the IP address, subnet, or other location information of the proxy server. Other formats may be used.

In one embodiment, the cloud connector 16 informs the DNS recursive server 18 co-located on a router to convey the subnet information in the EDNSO option in the DNS request. The DNS recursive server 18 forwards the DNS request, including the EDNSO option with the location information for the proxy, to the DNS authoritative server 24.

The DNS request or messages are exchanged within the DNS network using secured communications. For example, DNS-over-transport layer security (TLS) is used. Any encryption or other security may be used for preventing man-in-the middle attackers from modifying or removing the EDNSO option or other location information.

In act 46, the DNS authoritative server 24 receives the DNS message for content stored in the CDN. The DNS message is received from the DNS recursive server 18 or other DNS server. Using the secure communications, such as DNS-over-TLS, the DNS message with the SecaaS server location information (e.g., IP address, such as subnet address) is received. Any messaging protocol or communications may be used to receive the DNS message.

In act 48, the DNS authoritative server 24 identifies a dCDN server. The DNS message includes an IP address for the content. Using the IP address, the DNS authoritative server 24 determines that the requested content is hosted in the CDN. Since the CDN is hosting, the content may be provided by any of various dCDNs with the same content. The DNS is to be redirected to the dCDN instead of using the IP address in the request. Alternatively, the IP address in the request may be selected as the dCDN.

The DNS authoritative server 24 selects the dCDN to actually provide the content. The selection may be from two or more options, such as between tens or hundreds of options. The selection is of specific servers 22, 26, but may be of subnets or datacenters for hosting the content of the CDN.

Any suitable selection criterion or criteria may be used. Any now known or later developed CDN process for selecting the dCDN is performed. Parameters, such as load, ability to serve content without frame freezes, available bandwidth, latency, or number of hops, are used to select one dCDN over another. One criterion is the location of the SecaaS server or proxy 20. The address information, such as the subnet information or IP address of a specific server, indicates the geographic location. A look-up or address comparison may be used to find a dCDN close to the SecaaS server or datacenter. The dCDN is selected to be closer to the SecaaS server 20 than to the enterprise network 12, subnet of the enterprise network 12, the DNS recursive serer 18, the cloud connector 16, and/or the client device 14 (i.e., endpoint for receiving the requested content). Instead of using the IP address of the DNS recursive server 18 or network devices of the enterprise network 12, the IP address of the SecaaS server 20 is used. For example, the subnet information conveyed in the EDNSO option is used by the DNS authoritative server 24 to identify a dCDN located geographically closer to the SecaaS datacenter. In the example of FIG. 1, the DNS authoritative server 24 identifies the dCDN server 22 in Chicago as closer to the SecaaS server 20 than the dCDN server 26 in Delhi. The DNS is redirected to the dCDN server 22 in Chicago. Other criteria may be used with the location, such as selecting the dCDN server 22 in Chicago over a dCDN in Boston due to load balancing and/or latency measures.

In act 50, the DNS authoritative server 24 transmits the IP address for the selected dCDN as a response to the DNS message. The dCDN that will be providing the content to the SecaaS for inspection is identified in a DNS response. The address of the dCDN is either an IP address of a specific server or a subnet address for a group of servers, such as a dCDN hosted in a datacenter. The IP address for the dCDN is transmitted in a DNS message back to the local DNS server, such as the cloud connector 16, or through the cloud connector 16 to the client device 14. The transmission is pursuant to the same or different security as the DNS request sent to the DNS authoritative server 24.

In act 52, the cloud connector 16 receives the identification of the dCDN server 22 from the DNS authoritative server 24. The cloud connector 16 is configured to receive an IP address of a dCDN server 22 of the CDN selected using the IP address (e.g., IP address prefix) of the proxy server (e.g., SecaaS proxy 20). The dCDN server 22 geographically closer to the SecaaS server 20 is identified in the received DNS message. The IP address may be in the header of the DNS message rather than using EDNS. Alternatively, EDNS is used to communicate the IP address of the dCDN.

As another alternative to acts 50 and 52, the DNS authoritative server 24 forwards the request for content from the DNS message to the selected dCDN server 22. The request for content includes the proxy server IP address, so the dCDN serves the content to the SecaaS.

In act 54, the cloud connector 16 obtains the content from the selected dCDN server. The content is received via the SecaaS function. The cloud connector 16 is configured to cause the content to be inspected or filtered by the proxy server of the SecaaS. The cloud connector 16 redirects the request for the content to the cloud-based SecaaS server 20. The content is to be routed through and processed by the SecaaS server 20. The addressing is altered so that the SecaaS sever 20 outside the enterprise network 12 receives the request for the content. The request for content includes the IP address for the source of the content as the dCDN server 22.

The SecaaS server 20 receives the request for content. The SecaaS server 20 inspects the request or traffic and fetches a response. The inspection is of the URL to make sure the URL satisfies security policy. This may be identity-based, content-based, and/or other policy. If satisfying, the content is received from the dCDN server 22 in response to the request.

Based on the DNS redirection, the SecaaS server 20 obtains the content from the selected dCDN server 22. The selected dCDN server 22 is geographically near (e.g., within 500 miles) the SecaaS server 20. The cloud connector 16 re-directs traffic for the content provider (i.e., dCDN server 22) to SecaaS. SecaaS enforces the web filtering policy, so the request is routed to SecaaS so that the responsive content from the dCDN server 22 passes through SecaaS for filtering or other inspection.

The SecaaS server 20 filters any received content. Any policy may be used. For example, the content may be examined for an amount of “pink” or flesh tones. As another example, word searching may be performed to identify particular words or word strings that are not to be allowed. SecaaS subjects the traffic to deep packet inspection, behavioral analysis, heuristics, application Identification, or other process. Any SecaaS process may be used.

The cloud connector 16 receives the filtered content from the SecaaS server 20. Alternatively, the SecaaS server 20 inspects the content and authorizes serving the content by the dCDN server 22 to the cloud connector 16. In other embodiments, the content passes to the client device 14 without passing through a given cloud connector 16. The authorization and messaging to provide for serving the content are managed by the cloud connector 16 or other cloud connectors of the enterprise network 12. The client device 14 and/or other components of the enterprise network 12 receive the content after inspection by the SecaaS.

The SecaaS server 20 may be unreachable. Due to power outage, down time, or other problem, the SecaaS server 20 is not reachable or usable for the cloud connector 16. If the proxy server implementing the SecaaS function is unreachable by the cloud connector 16, then the IP address information for a back-up or other SecaaS server or datacenter is obtained. Act 40 is repeated for the other SecaaS server. For example, the subnet information of HTTP(S) proxy servers 20 in the backup SecaaS datacenter is obtained. The cloud connector 16 updates the DNS recursive server 18 on the router with the new subnet information. The DNS recursive server 18 propagates the new subnet information to the DNS authoritative server 24 so that the DNS authoritative server 24 may locate the dCDN closer to the backup SecaaS datacenter, including the SecaaS server 20.

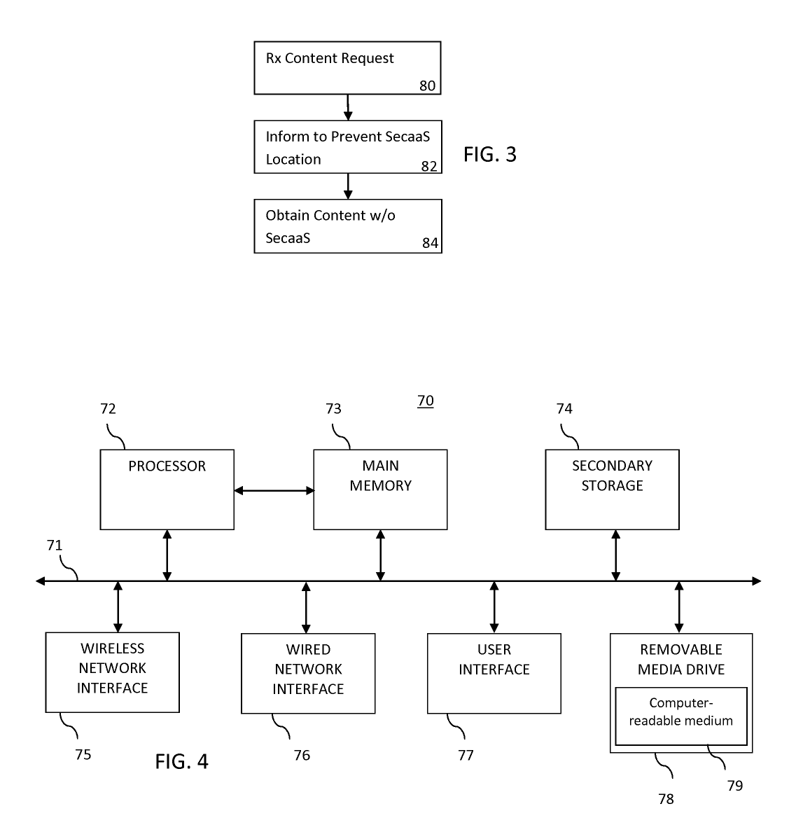

FIG. 3 shows an embodiment of a method for DNS redirection where SecaaS is used in general but not for a specific request for content. In some situations, such as for entry of private information or a request from a trusted source, the traffic or content request is not redirected to the SecaaS server 20. FIG. 3 shows one embodiment of this exception handling.

Additional, different, or fewer acts may be provided. For example, the methods are directed to serving a given request. Some or all of the acts are repeated for other requests. As another example, the acts of FIG. 2 are performed for some requests for content, and the acts of FIG. 3 are performed for other requests for content. The acts are performed in the order shown or a different order.

The method of FIG. 3 is implemented by the network of FIG. 1, by a cloud connector, by other enterprise network devices, by the DNS network, by the CDN network, or by other networks or software. Any of various devices and corresponding applications may implement all or portions of the method.

In act 80, a request for content is received, such as received by the cloud connector 16 as discussed for act 42. The request for content is from any of the client devices 14. The same client device 14 may generate one request for content to be inspected by SecaaS server 20 and another request for content not to be inspected. Different client devices 14 may generate different requests for content, such as content to be inspected and content not to be inspected.

The cloud connector 16 is configured with one or more domains for which the content is not directed or re-directed to the SecaaS server 20. A table of trusted domains or IP addresses is maintained and used by the cloud connector 16 to determine whether SecaaS is to be used. Upon receipt of the request for content, the cloud connector 16 determines whether or not the request is for content to be inspected by SecaaS.

Where the content is hosted in a CDN and is to be redirected to the SecaaS server 20, the method described above for FIG. 2 is used. Where the content is not to be redirected to the SecaaS server 20 but is hosted in a CDN, the DNS redirection is performed based on the location information for network devices of the enterprise network 12 (e.g., subnet of the client device 14) or the DNS recursive server 18.

In act 82, to avoid unintentional routing of the request for content and any included private information, the cloud connector 16 informs the DNS recursive server 18 to prevent including the location information in the DNS message. For example, the cloud connector 16 informs the DNS recursive server 18 on the router not to add the EDNSO option for the DNS requests to resolve these trusted domains. As a result, the DNS authoritative server 24 locates a dCDN closer to the endpoint (e.g., client device 14), such as the dCDN server 26 in Delhi where the enterprise network 12 is in Bangalore. In alternative embodiments, the cloud connector 16 generates the DNS request without the location information SecaaS server 20. Without the information, the DNS authoritative server 24 locates the dCDN server 26 closer to the client device 14.

In act 84, the client device 14 obtains the content from the dCDN server 26 without the SecaaS function. The cloud connector 16 passes the DNS message to the DNS network. The DNS authoritative server 24 provides the IP address for the selected dCDN server 26. In response, the cloud connector 16 routes the request for content to the dCDN server 26. The dCDN server 26 replies with the content address for the client device 14.

FIG. 4 is a simplified block diagram of an example network device, such as the client device 14, cloud connector 16, DNS recursive server 18, DNS authoritative server 24, or SecaaS server 20 of FIG. 1. In FIG. 4 the example network apparatus or device 70 corresponds to network elements or computing devices that may be deployed in the network 12 or network 10. The network device 70 includes software, firmware, and/or hardware to perform any one or more of the activities or operations for caching with security as a service. Similarly, the various components of the network device 70 may be implemented as software, firmware, and/or hardware.

The network device 70 includes a processor 72, a main memory 73, a secondary storage 74, a wireless network interface 75, a wired network interface 76, a user interface 77, and a removable media drive 78 including a computer-readable medium 79. A bus 71, such as a system bus and a memory bus, may provide electronic communication between processor 72 and the other components, memory, drives, and interfaces of network device 70.

Additional, different, or fewer components may be provided in network device 70. The components are intended for illustrative purposes and are not meant to imply architectural limitations of network devices such as network device 70. For example, the network device 70 may include another processor and/or not include the secondary storage 74 or removable media drive 78. Network device 70 may include more or less components than shown.

The processor 72, which may also be referred to as a central processing unit (CPU), is any general or special-purpose processor capable of executing machine readable instructions and performing operations on data as instructed by the machine readable instructions. The main memory 73 may be directly accessible to processor 72 for accessing machine instructions and may be in the form of random access memory (RAM) or any type of dynamic storage (e.g., dynamic random access memory (DRAM)). The secondary storage 74 may be any non-volatile memory, such as a hard disk, which is capable of storing electronic data including executable software files. Externally stored electronic data may be provided to computer 70 through one or more removable media drives 78, which may be configured to receive any type of external media 79, such as compact discs (CDs), digital video discs (DVDs), flash drives, external hard drives, or any other external media.

The wireless and wired network interfaces 75 and 76 may be provided to enable electronic communication between the network device 70 and other network devices via one or more networks. In one example, the wireless network interface 75 includes a wireless network controller (WNIC) with suitable transmitting and receiving components, such as transceivers, for wirelessly communicating within the network 10. The wired network interface 76 may enable the network device 70 to physically connect to the network 10 by a wire, such as an Ethernet cable. Both wireless and wired network interfaces 75 and 76 may be configured to facilitate communications using suitable communication protocols, such as the Internet Protocol Suite (TCP/IP).

The network device 70 is shown with both wireless and wired network interfaces 75 and 76 for illustrative purposes only. While one or both wireless and hardwire interfaces may be provided in the network device 70, or externally connected to network device 70, only one connection option is needed to enable connection of network device 70 to the network 10, 12. The network device 70 may include any number of ports using any type of connection option.

A user interface 77 may be provided to allow a user to interact with the network device 70. The user interface 77 may be a display device (e.g., plasma display panel (PDP), a liquid crystal display (LCD), or a cathode ray tube (CRT)). In addition, any appropriate input device may also be included as user interface 77. Suitable input devices may include, but are not limited to including, a keyboard, a touch screen, a mouse, a trackball, microphone (e.g., input for voice recognition), buttons, and/or a touch pad.

Instructions embodying the activities or functions described herein may be stored on one or more external computer-readable media 79, in main memory 73, in the secondary storage 74, or in the cache memory (not shown) of processor 72 of the network device 70. These memory elements of network device 70 are typically non-transitory computer-readable media. The logic for implementing the processes, methods and/or techniques discussed herein are provided on non-transitory computer-readable storage media or memories, such as a cache, buffer, RAM, removable media, hard drive or other computer readable storage media. Computer readable storage media include, but are not limited to including, various types of volatile and nonvolatile storage media. Thus, ‘computer-readable medium’ is meant to include any medium that is capable of storing instructions for execution by network device 70 that cause network device 70 to perform any one or more of the activities disclosed herein.

The instructions stored on the memory 73, 74, or 79 as logic may be executed by the processor 72. The functions, acts, or tasks illustrated in the figures or described herein are executed in response to one or more sets of instructions stored in or on computer readable storage media. The functions, acts, or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing, and the like.

Additional hardware may be coupled to the processor 72 of the network device 70. For example, memory management units (MMU), additional symmetric multiprocessing (SMP) elements, physical memory, peripheral component interconnect (PCI) bus and corresponding bridges, or small computer system interface (SCSI)/integrated drive electronics (IDE) elements may be coupled to the processor 72. The network device 70 may include any additional suitable hardware, software, components, modules, interfaces, or objects that facilitate operation. This may be inclusive of appropriate algorithms and communication protocols that allow for the effective protection and communication of data. Furthermore, any suitable operating system is configured in network device 70 to appropriately manage the operation of the components included in network device 70.

While various embodiments have been described, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method comprising:
obtaining, at a cloud connector device, location information for a proxy server of a security as a service (SecaaS) function;
receiving, at the cloud connector device, a content request from a user device for content hosted in a content delivery network (CDN);
forwarding a domain name system (DNS) request, with location information, to a DNS authoritative server;
receiving an identification of a downstream CDN server from the DNS authoritative server, the identification of the downstream CDN based on the location information for the proxy server of the SecaaS function; and
obtaining the content from the downstream CDN server through the proxy server of the SecaaS function.

2. The method of claim 1 wherein obtaining the location information comprises obtaining an Internet Protocol address for a subnet.

3. The method of claim 1 wherein obtaining the location information comprises obtaining the location information for a SecaaS datacenter.

4. The method of claim 1 wherein forwarding comprises informing a DNS recursive server to route the DNS request with the location information.

5. The method of claim 1 wherein receiving the content request comprises obtaining the content with a transparent proxy at the cloud connector device, the cloud connector device comprising an edge router of an enterprise network.

6. The method of claim 1 wherein forwarding comprises forwarding the location information in an extension mechanism for DNS (EDNS) option of the DNS request.

7. The method of claim 1 wherein receiving the identification comprises receiving the identification of the downstream CDN , the downstream CDN being geographically closer to the proxy server than to the cloud connector device.

8. The method of claim 1 wherein receiving the identification comprises receiving an Internet Protocol address of the downstream CDN.

9. The method of claim 1 wherein obtaining the content comprises receiving the content after filtering of the content by the SecaaS function.

10. The method of claim 1 further comprising:
determining that a different proxy server for the SecaaS function is unreachable by the cloud connector; and
wherein obtaining comprises obtaining from the proxy server as a backup of the different proxy server.

11. The method of claim 1 further comprising:
receiving, at the cloud connector device, another content request for content hosted in the CDN, the other content request being received from another user device or the user device;
informing a DNS recursive server to prevent including the location information in a DNS request for the other content; and
obtaining the another content from another downstream CDN server without the SecaaS function, the another downstream CDN server assigned based on a location of the user device or the other user device.

12. Logic encoded in one or more non-transitory computer-readable media that includes code for execution and when executed by a processor is operable to perform operations comprising:
receiving a domain name service (DNS) message for content stored in a content delivery network (CDN), the DNS message having address information for a security as a service (SecaaS) server;
identifying a downstream CDN server based, at least in part, on the address information for the SecaaS server; and
transmitting an address for the downstream CDN server in response to the DNS message.

13. The logic encoded in the one or more non-transitory computer readable media of claim 12 wherein receiving comprises receiving the DNS message with the address information comprising subnet information for the SecaaS server.

14. The logic encoded in the one or more non-transitory computer readable media of claim 12 wherein receiving comprises receiving with the address information in an extension mechanism for DNS (EDNS) option of the DNS message.

15. The logic encoded in the one or more non-transitory computer readable media of claim 12 wherein identifying comprises identifying based on a location indicated by the address information, the downstream CDN server being located geographically closer to the SecaaS server than an endpoint for receiving the content.

16. The logic encoded in the one or more non-transitory computer readable media of claim 12 wherein transmitting the address comprises transmitting an Internet protocol address for the downstream CDN server to provide the content to the SecaaS server.

17. An apparatus comprising:
an interface connected with a client device requesting content from a content delivery network (CDN);
a gateway device connected with the interface, the gateway device configured to inform a domain name service (DNS) recursive server of Internet protocol (IP) address information of a proxy server for the content and configured to receive an IP address of a downstream CDN server of the CDN selected using the IP address information of the proxy server.

18. The apparatus of claim 17 wherein the gateway device is configured to request subnet information from the proxy server, the subnet information being the IP address information of the proxy server.

19. The apparatus of claim 17 wherein the gateway devices is configured to cause the content to be filtered by the proxy server acting as a security as a service (SecaaS) server, the downstream CDN server of the CDN being geographically closer to the proxy server than the gateway device based on the IP address information of the proxy server.

20. The apparatus of claim 17 wherein the gateway device is configured to cause the DNS recursive server to create a DNS message for a DNS authoritative server with an extension mechanism for DNS (EDNS) option in the DNS message having the IP address information of the proxy server.
